(19) United States
(12) Patent Application Publication
(10) Pub. No.: US 2012/0279375 A1
(43) Pub. Date: Nov. 8, 2012

(54) Method and apparatus for securing a guitar strap

(76) Inventor: James Page, Hyattsville, MA (US)

(21) Appl. No.: 12/803,199

(22) Filed: Jun. 19, 2010

(51) Int. Cl. G10G 5/00

(52) U.S. Cl. 84/327

(57) ABSTRACT

A guitar strap securing member has a head and a shaft extending from the head. The shaft is dimensioned to pass though a through-hole of a strap. The head is substantially larger than the through-hole. The strap securing member shaft secures the guitar strap to a receptacle on and supported by a guitar body by inserting the shaft of the guitar strap securing member through the through through-hole of the strap and into the receptacle. The head of the inserted guitar strap securing member, larger than the through-hole, and the shaft in the channel, secures the guitar strap.

This application claims priority to U.S. Provisional Application Ser. No. 61/258,863, filed Jun. 18, 2009, which is hereby incorporated by reference in its entirety

### TECHNICAL FIELD

The technical field pertains generally to removably securing a strap to a guitar or other stringed instrument.

### BACKGROUND

A guitar strap is well a known flexible, lightweight accessory typically resembling belt or strap, typically having an adjustable length and attaching at one end to an upper region of a guitar neck, and at a lower end to a button or equivalent structure at a bottom portion of a guitar body. The field of this invention is the secure and practical attachment of a strap to a guitar and not, except where explicitly stated, the particular species or style of the guitar itself. Therefore, for purposes of this description, “guitar” means any stringed instrument that is supported by the musician playing it by means of any structure within the plain and commonly understood meaning of a “strap.” Illustrative examples of such instruments that are encompassed by this description's use of the term “guitar” include, without limitation, any of the various sized six or twelve acoustic guitars, six or twelve string solid body electric guitars, six or twelve string hollow or semi-hollow body electric guitars and, in addition, electric bass guitars having, for example, four, five, six or more strings, banjos and mandolins.

For purposes of this description, the term “lower portion of the guitar body” means any surface of a guitar body to which the lower end of a strap connects. As is well understood by persons of ordinary skill in the art of guitars, phrases such as “the lower portion of the guitar body” are relative terms, not typically susceptible to a sharp definition. For example, referring to Prior Art FIG. 1, one example “lower portion” 4, and may include any of the surface 4A, which is the portion of the curved wall shown in front projection extending perpendicular from the front face 4B of the guitar body, to its opposite face (not shown in Prior Art FIG. 1).

With continuing reference to Prior Art FIG. 1, one means for attaching a guitar strap (not shown in Prior Art FIG. 1) to the lower portion a typical example arrangement, is a strap button 8, which may be screwed into any location on the lower portion. The illustrated location of the example strap button 8 is one example. This strap button 8 structure and method has inherent shortcomings. For example, one is that it requires an additional perforation of the guitar body. Another is that the simple threaded engagement of the threaded portion (not shown) of the strap button 8 may become loose with time and use and, as a resulting, may fail by pulling out of the wood of the guitar body. Exacerbating of this problem, particularly with acoustic guitars and hollow body electrics, is the fact that the body is typically thin.

Referring still to FIG. 1, another well-known structure and method of securing the lower end of a guitar strap to the lower portion of a guitar body is to form a button or endpin section 10 (hereinafter referenced as “endpin”) on the electric jack receptacle, (hereinafter which is collectively labeled as 12. First, it will be understood that FIG. 1 is a demonstrative example, as some guitars, especially some acoustic guitars, do not have electric jacks such as 12. It is also understood that the position at which the example jack 12 is located is, as stated, only one example. Some guitars, including acoustics, position the jack 12 at a location displaced from the depicted example position. Other locations are known in the art.

The known structure and method of attaching a lower end of a guitar strap to a lower portion of a guitar is further described in reference to Prior Art FIGS. 2 and 4. Prior Art FIG. 2 shows a portion of a guitar strap 20, including a lower end 20A, having at least one through-slit 22. As readily understood by persons of ordinary skill in the art, an upper end (not shown) of the guitar strap 20 attaches to an upper portion (not shown) of the guitar, typically at the nut (the top bridge above the first fret, not shown) The particular attachment of the top portion of the strap is not relevant to the invention and, therefore, further detailed description is omitted.

Prior Art FIG. 3 shows a front view of an RCA type monaural plug 16 that typically connects to an instrument-to-amplifier cable 18.

Prior Art FIG. 4 shows a front cut-away elevation view of the Prior Art FIG. 2 guitar strap attached to the Prior Art FIG. 1 endpin 10 of the electrical receptacle 12. As can be seen pushing the endpin 10 through the slit (FIG. 2 item 22, not visible in FIG. 4) displaces its sides (not separately numbered) and, after passing through, the sides move together again, essentially capturing the endpin 10.

There are inherent problems with the endpin 10 and jack 12 arrangements, though. One is that the mechanical connection between button or endpin 10 and the slit 22 is not always secure. There are various causes, some being inherent to the design. For example, the diameter D1 of the endpin 10 is limited by the practicality be being able to fit that endpin through the slit 22. If the diameter D1 is too large, the musician will not be able to change straps. Another cause is the slit 22 may enlarge by wear and tear. Another cause is that the diameter D1 is limited by the anticipated least flexibility of the strap materials surrounding the slit 22. Thick nylon, for example, may have a limited ability to stretch. Leather straps, on the other hand, have significantly greater flexibility. Therefore, an endpin 10 dimensioned to hold well using a nylon strap will not hold well when using a leather strap.

With continuing reference to Prior Art FIG. 4, it can be seen that the cable 18 provides the additional security that, for the above-described, reasons, cannot be provided by the endpin 10 and slit 22 alone. Stated more specifically, in instances when the instrument is being played with the cable 18, if the endpin 10 pulls through the slit 22 the strap 20 cannot come off, because it is still secured by the cable 18. However, when a musical instrument fitted with an endpin 10 or other pickup jack is not being played with have an instrument-to-amplifier cable 18 inserted in it, if the slit 22 pulls off of the endpin 10, the strap 20 disengages from the instrument. The result is that the instrument can fall, oftentimes falling to the floor. This can result is resulting in serious damage to the instrument.

### BRIEF DESCRIPTION OF THE DRAWINGS

Prior Art FIG. 1 depicts a related art acoustic guitar having a typical strap button;

Prior Art FIG. 2 depicts a lower portion of a conventional guitar strap;

Prior Art FIG. 3 shows a front view of an RCA type monaural plug that typically connects to an instrument-to-amplifier cable;

Prior Art FIG. 4 shows the FIG. 2 conventional guitar strap connected via an endpin portion of a guitar jack;

FIG. 5 depicts a front view of one example according to one embodiment of the present invention;

FIG. 6 shown a top view of the FIG. 5 example, from projection AA-AA;

FIG. 7 shows a bottom view of the FIG. 5 example, from projection BB-BB;

FIG. 8 shows a front partial cut-away projection of the one example assembled multi-piece guitar strap securing structure configured as in FIG. 8;

FIG. 9 shows a front projection exploded view of the one example multi-piece guitar strap securing device according to FIGS. 5-8;

FIG. 10 shows one example lens magnification feature of one guitar strap securing device according to one or more embodiments.

### DETAILED DESCRIPTION

The following detailed description of the invention is in reference to accompanying drawings, which form a part of this description. The drawings are illustrative examples of specific example configurations and arrangements within one or more embodiments, to assist a person of ordinary skill to form an understanding of the inventive concepts sufficient for the person, applying the knowledge and skills such a person possesses, to practice according to the claimed invention. The scope of the embodiments and range of implementations, however, are not limited to these specific illustrative examples. Instead, other configurations, arrangements and implementations for practicing according to the embodiments as will be obvious to persons of ordinary skill in the relevant arts upon reading this description.

In the drawings, like numerals appearing in different drawings reference illustrative example structure that, in the depicted example, is or may be identical or substantially identical between the different drawings.

Unless otherwise stated or made clear from the description, the drawings are not necessarily to scale. A person of ordinary skill in the art, however, can readily determine from the drawings, and the accompanying description, the range of relative scale among the structural components of the various implementations that, in view of this description, such persons will readily identify.

Unless otherwise stated or made clear from their context in the description, terms and phrases such as “formed on,” “arranged on” and “provided on” define only a spatial relationship of structure(s) and, unless otherwise stated or made clear from the context, do not define any sequence or order of fabrication. Further, instances of such terms and phrase as “formed on,” “arranged on” and “provided on,” with respect to the relation of structures, do not necessarily mean the structures are separate, at any time during their fabrication, or that the structures are separable.

It will be obvious to persons of ordinary skill in the art, upon reading this disclosure, that various details of subject matter known to such persons is omitted, as this avoids obscuring novel features and aspects of the embodiments. Similarly, at instances at which details are included, it will be understood by persons of ordinary skill in the art, from the context of the instance, that such details may be described only to the extent pertinent to particular features or aspects of an embodiment.

In addition, example embodiments and aspects may be described separately, or as having certain differences. Separate description or description of differences, however, does not necessarily mean the respective embodiments or aspects are mutually exclusive. For example, a particular feature, function, or characteristic described in relation to one embodiment may be included in, or adapted for other embodiments.

### ILLUSTRATIVE GENERAL EMBODIMENTS

As previously stated, in the current art, when a musician is not using a cable such as item 18 connected through a plug 16 to an endpin 10 of a jack 12, there is an insufficient securing of the strap 20 to endpin jack. The screw-in button 8 is inadequate for the same reasons, and then some. First, the diameter (not separately labeled) of the button 8 is limited for the same reasons as the diameter D1 of the endpin 10. Stated simply, if the diameter is too large the button 8 cannot be pushed through the slit 22. In addition, the threaded screw portion of the button 8 is prone to coming loose and pulling out of the guitar body. Even further, the button 8 never has the added security of an electrical cord, because the button 8 is not part of a jack 12.

The present embodiments provide various advancements in the art of guitar strap attachment. One is a simple structure, easy to manufacture that ensures secure attachment of a strap to a guitar, without additional hardware and without special steps for attachment or removal. Another is no requirement for custom modification of, or adding any structure to existing guitars. On the contrary, according to one aspect of embodiment, the complete structure may be a single unit, which may be a homogenous structure, and the complete method may be practiced by inserting the one structure through a conventional slit of a conventional guitar strap and into the convention jack of a guitar.

As will be readily understood by persons of ordinary skill in the art, this and other embodiments provide secure, but readily removable attachment of a guitar strap, with a very substantially reduced, effectively eliminated, probability of a strap coming off and a guitar falling to the floor.

According to one aspect, a structure having one or more embodiments may be readily constructed, at time of manufacture or assembled in the field, from a simple multi-piece arrangement. Among other features and benefits of this multi-piece aspect is ease-of-manufacture, and flexibility to adopt embodiments to various different guitar jacks. According to one implementation, the multi-piece structure may be secured into a unitary structure by a single threaded screw.

According to one aspect, a simple multi-piece structure may include a non0conducting sleeve, thereby enabling use with conventional battery-powered guitar am amplifiers, without necessitating the battery being removed to prevent the structure from switching on the amplifier.

According to one aspect, various structures provide capability of various aesthetic designs, including optical magnification of a designer or vendor logo.

### EXAMPLES ACCORDING TO ONE OR MORE EMBODIMENTS

Referring now to the figures, illustrative examples among the ranges of arrangements, architectures, systems and structures for practicing one or more of the various example embodiments will be described. It will be understood that the specific examples are presented only for purposes of further assisting a person of ordinary skill in the art form a fuller understanding of the present invention and its various concepts, features, and embodiments for practicing the same.

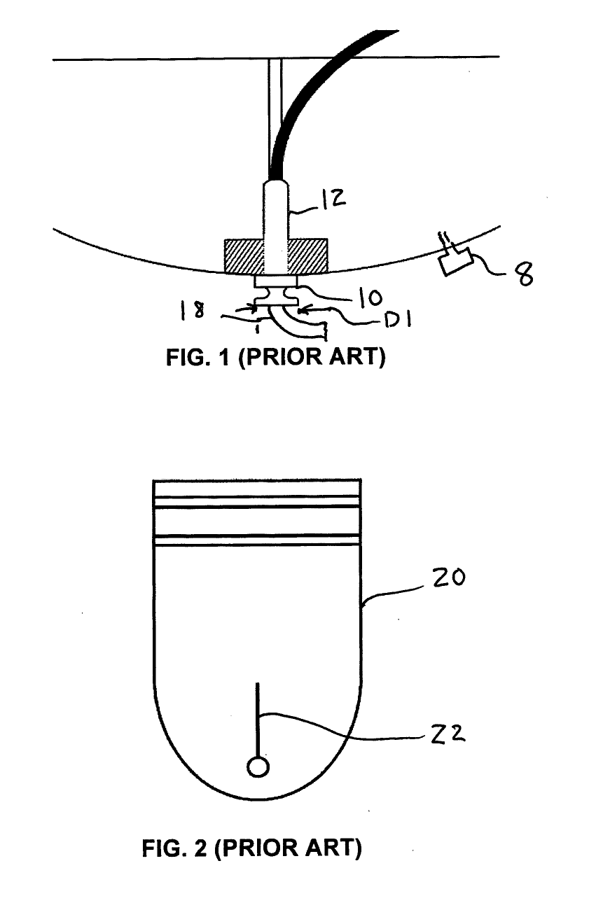

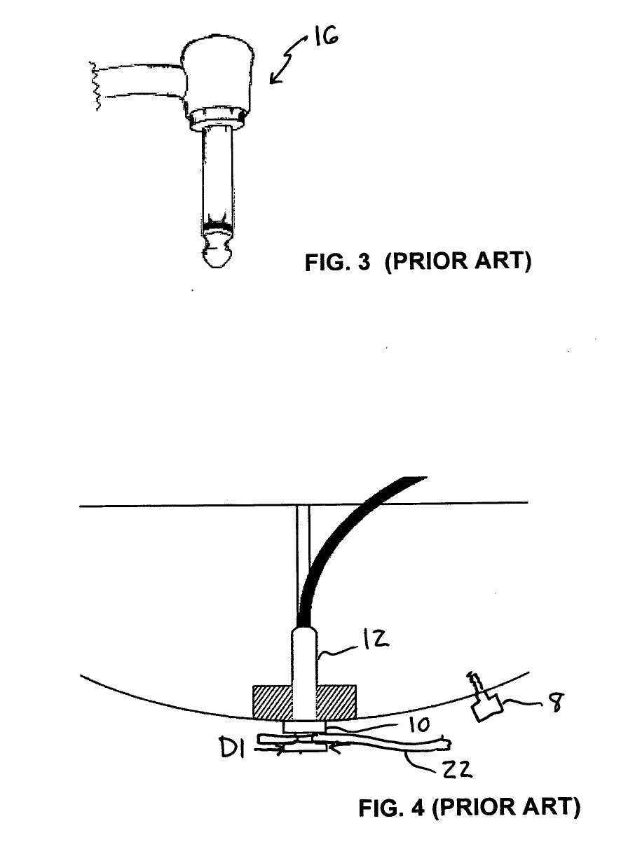

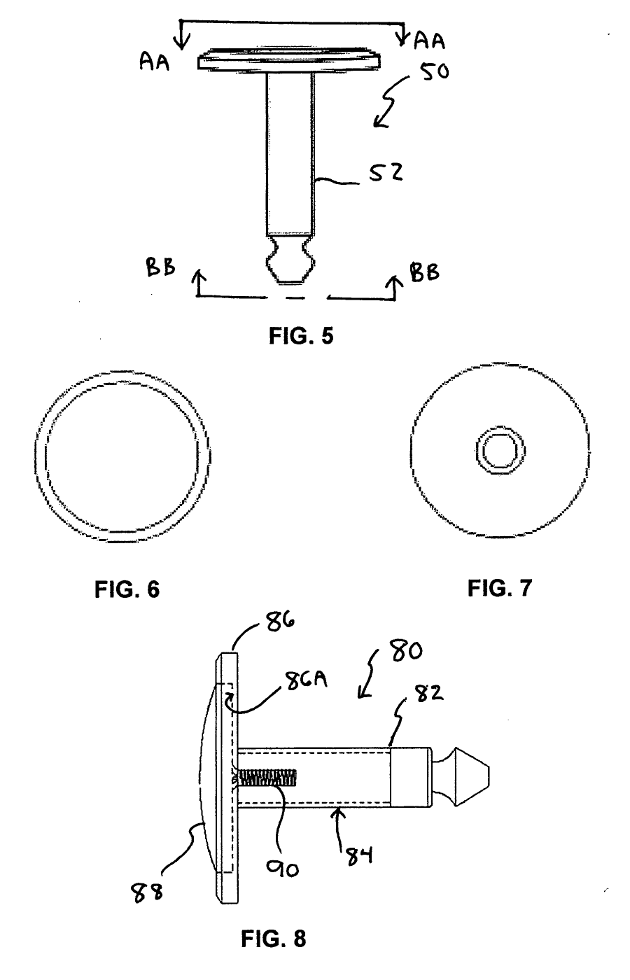

Referring first to FIG. 5, depicted is a front view of one example 50 according to one embodiment of the present invention. The example includes a shaft 52, shaped identical to the RCA connector depicted FIG. 2.

FIG. 6 shows a top view of the FIG. 5 example, from projection AA-AA.

FIG. 7 shows a bottom view of the FIG. 5 example, from projection BB-BB.

FIG. 8 shows a front partial cut-away projection of one example multi-piece guitar strap securing structure 80 according to one embodiment. Referring to FIG. 8, the example 80 includes a shaft 82 of, for example, a conducting metal having an outer sleeve 84 of a non-conducting material, connected to a head 86. In the depicted example, a structure 86A of the head 86 supports a clear, or translucent lens 88. The sleeve 84 is dimensioned to fit around the shaft 82. Through the clear or translucent lens 88 can be seen the head (not separately numbered) of a screw 90. The head of the screw 90 may, by design methods readily obvious to persons of ordinary skill in the art upon reading this disclosure, be obscured. Further, the screw 90 is but one example structure for securing the head 86 to the shaft 82. Other attaching means will be obvious to persons of ordinary skill in the art upon reading this disclosure. Further, a light emitting diode (LED) or equivalent light source may be incorporated into the shaft 82, or the head 86, for shining through the lens 88 or through the sleeve 84.

FIG. 9 shows a front projection exploded view of the one example multi-piece guitar strap securing device according to FIG. 8.

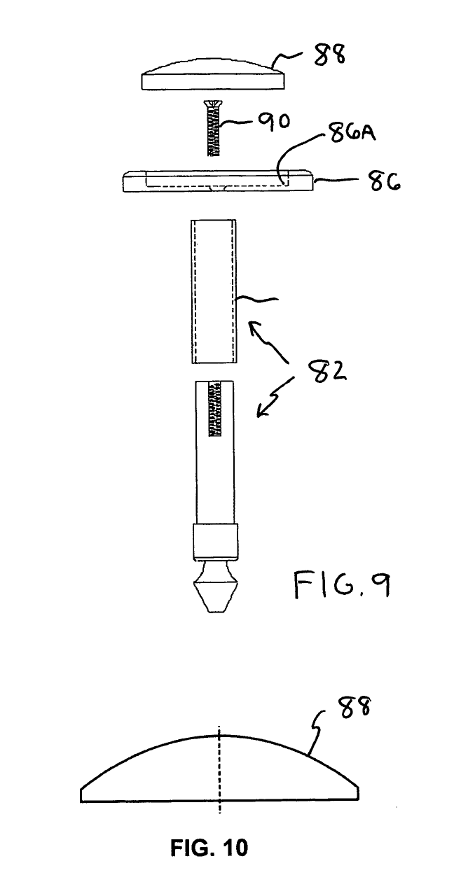

FIG. 10 shows one example of the lens 88, providing a magnification feature of one guitar strap securing device according to one or more embodiments. The magnification may be, for example, of a brand logo (not shown) formed on the surface 86B of the head 86.

The above-described illustrated examples are only, as the name implies, examples. As is readily apparent to those skilled in the art, variations and modifications can be affected while remaining within the spirit and scope of the invention. Accordingly, the foregoing disclosure, description, and figures are for illustrative purposes only and do not in any way limit the invention, which is defined only by the claims.

We hereby claim:

1. A guitar strap securing device comprising:
a receptacle having a channel for receiving and holding a shaft, having an outer structure with an inner support supporting the channel and a securing structure for mounting to a guitar body;
a securing member having a head and a shaft extending from the head, the shaft shaped and dimensioned to be received by the receptacle channel, and having a head substantially larger than a given through-hole of a given strap,
wherein the shaft is dimensioned to be inserted through the through-hole of the strap, and
wherein inserting the shaft through the through-hole of a strap and into the channel body of a receptacle mounted to a guitar body secures the strap to the guitar body.

2. The guitar strap securing device of claim 1, wherein the receptacle includes a spring for urging the shaft the securing member to remain in the channel when inserted into the channel.

3. The guitar strap securing device of claim 1, wherein the securing member includes the head secured to the shaft by a screw.

4. The multimedia control of claim 3, wherein the head includes a support structure for a lens.

5. The multimedia control of claim 1, wherein the shaft includes a conducting center shaft surrounded by a non-conducting sleeve.
